(19) United States
(12) Patent Application Publication
(10) Pub. No.: US 2018/0005769 A1
(43) Pub. Date: Jan. 4, 2018

(54) SEPARATOR WINDING CORE, SEPARATOR ROLL, AND METHOD OF PRODUCING SEPARATOR ROLL

(71) Applicant: Sumitomo Chemical Company, Limited, Tokyo (JP)

(72) Inventor: Hirohiko HASEGAWA, Niihama-shi (JP)

(21) Appl. No.: 15/636,955

(22) Filed: Jun. 29, 2017

(30) Foreign Application Priority Data
Jun. 30, 2016 (JP) 2016-130287
May 8, 2017 (JP) 2017-092281

(51) Int. Cl. H01G 11/24; H01M 2/16; H01M 2/14; H01G 11/28; H01M 6/10; H01G 9/02; H01G 11/52

(52) U.S. Cl. CPC H01G 11/24; H01M 6/10; H01M 2/1606; H01G 9/02; H01M 2/145; H01G 11/28; H01G 11/52

(57) ABSTRACT

A separator winding core is configured such that at least one of side surfaces has a large frictional force between the side surface and one side surface of another separator winding core of the same type. Such a separator winding core is less likely to fall down when it is stacked on another separator winding core of the same type. Provided is a separator winding core having side surfaces around which no separator is to be wound and at least one of which has an arithmetic mean roughness of not less than 0.16 μm. The separator winding core is stackable with one or more other separator winding cores of the same type in such a position that one of the side surfaces of the separator winding core faces upward while the other one of the side surfaces of the separator winding core faces downward.

This Nonprovisional application claims priority under 35 U.S.C. §119(a) on Patent Application No. 2016-130287 filed in Japan on Jun. 30, 2016, and Patent Application No. 2017-092281 filed in Japan on May 8, 2017, the entire contents of which are hereby incorporated by reference.

### TECHNICAL FIELD

The present invention relates to (i) a separator winding core around which a separator for a nonaqueous electrolyte secondary battery (hereinafter referred to as a “nonaqueous electrolyte secondary battery separator”) is to be wound, (ii) a separator roll in which the nonaqueous electrolyte secondary battery separator is wound around the separator winding core, and (iii) a method of producing the separator roll.

### BACKGROUND ART

Patent Literature 1 discloses an example of a shape of a separator winding core (hereinafter also referred to as a “core”) around which a nonaqueous electrolyte secondary battery separator is to be wound, the nonaqueous electrolyte secondary battery separator being continuously produced while being conveyed by a conveying system such as a roller. The produced nonaqueous electrolyte secondary battery separator is supplied as a product in a state of being wound around the separator winding core.

The core disclosed in Patent Literature 1 includes (i) an outer cylindrical member around which the nonaqueous electrolyte secondary battery separator is to be wound, (ii) an inner cylindrical member which functions as a bearing into which a shaft is to be fitted, and (iii) a support member (hereinafter also referred to as a “rib”) which connects to the outer cylindrical member and the inner cylindrical member. The produced nonaqueous electrolyte secondary battery separator is supplied in the form of a roll in which the produced nonaqueous electrolyte secondary battery separator is wound around the outer cylindrical member.

### CITATION LIST

### Patent Literature

### [Patent Literature 1]

Japanese Patent Application Publication, Tokukai, No. 2013-139340 (Publication Date: Jul. 18, 2013)

### SUMMARY OF INVENTION

### Technical Problem

In a case where an outer circumferential surface of the core is damaged by, for example, contact with another core, the ground or the like, the damaged outer circumferential surface remotely causes damage of a separator which is to be wound around the damaged outer circumferential surface. The core, therefore, needs to be stored such that the outer circumferential surface of the outer cylindrical member of the core does not contact another core, the ground or the like.

A method of storing a core while keeping an outer circumferential surface of the core from contact with another core, the ground or the like includes a method of storing the core in a state of being stacked such that one of side surfaces of the core face upward while the other one of the side surfaces face downward.

It is possible to store a produced separator by storing a separator roll in which the produced separator is wound around a core. A method of storing the separator includes a method of storing the separator roll in a state of being stacked (i) such that one of side surfaces of the separator roll faces upward while the other one of the side surfaces of the separator roll faces downward and (ii) such that the separator does not contact, for example, another core, another separator, and the ground because, in general, the separator has a width smaller than that of the core.

A situation, however, is assumed in which impact or vibration is generated on the stacked core by, for example, accidental collision of a human hand or the like with the stacked core, or conveyance of the stacked core. The above storing method has, for example, the following problem: in a case where the side surface of the stacked core has a small frictional force, generation of the impact or the vibration causes the stacked core to slip down. This problem will also be caused in a case where the separator roll is stacked to be stored.

Paten Literature 1 clearly discloses neither how to store a core and a separator roll nor a frictional force of a side surface of the core. Patent Literature 1 will cause the above problem.

The present invention was made in view of the problem, and an object of the present invention is to realize a separator winding core and a separator roll each of which is easily handled since they are configured (i) such that a frictional force of one of side surfaces is so large that, for example, the occurrence of sliding under impact is decreased.

### Solution to Problem

In order to attain the object, a separator winding core in accordance with an embodiment of the present invention is configured to be a separator winding core around which a nonaqueous electrolyte secondary battery separator is to be wound, the separator winding core having side surfaces around which the nonaqueous electrolyte secondary battery separator is not to be wound and at least one of which side surfaces has an arithmetic mean roughness of not less than 0.16 μm. With the configuration, the at least one of the side surfaces has a large frictional force. It is therefore possible to provide an easy-to-handle separator winding core whose sliding and misalignment are suppressed.

In the configuration, the separator winding core can be configured such that an average value of the surface roughness is not more than 3 μm. The configuration makes it possible to provide an easily cleanable separator winding core having the aforementioned advantages.

In the configuration, the separator winding core can be configured such that the average value of the surface roughness is not more than 0.9 μm. The configuration makes it possible to provide a more easily cleanable separator winding core having the aforementioned advantages.

In the configuration, the separator winding core can be configured to be stackable, with one or more other separator winding cores of the same type, in such a position that one of the side surfaces of the separator winding core faces upward while the other one of the side surfaces of the separator winding core faces downward. The configuration makes it possible to stack two or more separator winding cores to be stored.

In the configuration, the separator winding core can be configured to be made of any one of an ABS resin, a polyethylene resin, a polypropylene resin, a polystyrene resin, a polyester resin, and a vinyl chloride resin. The configuration makes it possible to produce the separator winding core by resin molding with the use of a mold.

A separator roll in accordance with an embodiment of the present invention is configured to be a separator roll in which the nonaqueous electrolyte secondary battery separator is wound around the separator winding core. The configuration makes it possible to provide an easily storable separator roll and a separator wound in the easily storable separator roll.

A method, in accordance with an embodiment of the present invention, of producing a separator roll is configured to be a method of producing a separator roll in which a nonaqueous electrolyte secondary battery separator is wound around a separator winding core, the method including the steps of: producing the nonaqueous electrolyte secondary battery separator; and winding the nonaqueous electrolyte secondary battery separator around the separator winding core, the separator winding core having side surfaces around which the nonaqueous electrolyte secondary battery separator is not to be wound and at least one of which side surfaces has an arithmetic mean roughness of not less than 0.16 μm.

The method can be configured such that the arithmetic mean roughness is not more than 3 μm.

The method can be configured such that the arithmetic mean roughness is not more than 0.9 μm.

### Advantageous Effects of Invention

The present invention can provide a separator winding core and a separator roll each of which is (i) less likely to fall down even in a case of being stacked such that one of side surfaces of a corresponding one of the separator winding core and the separator roll faces upward while the other one of the side surfaces of the corresponding one of the separator winding core and the separator roll faces downward and (ii) easily handled when stored.

### BRIEF DESCRIPTION OF DRAWINGS

FIG. 1 is a view schematically illustrating a cross sectional configuration of a lithium-ion secondary battery.

FIG. 2 is a view schematically illustrating states of the lithium-ion secondary battery illustrated in FIG. 1.

FIG. 3 is a view schematically illustrating states of another lithium-ion secondary battery which is different in configuration from the lithium-ion secondary battery illustrated in FIG. 1.

FIG. 4 is a view schematically illustrating a configuration of a slitting apparatus for slitting a separator.

FIG. 5 is a front view illustrating (i) a separator winding core in accordance with an embodiment of the present invention, and (ii) a separator roll in which a separator is wound around the separator winding core.

FIG. 6 is a view illustrating an example of a method of storing separator winding cores in accordance with an embodiment of the present invention.

FIG. 7 is a view illustrating an example of a method of storing separator winding cores in accordance with a reference embodiment.

### DESCRIPTION OF EMBODIMENTS

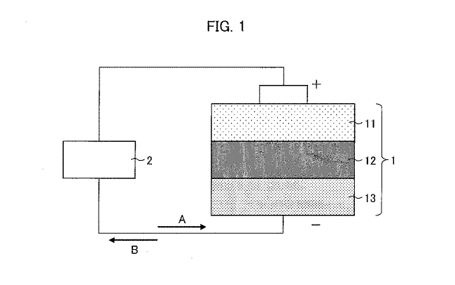

The following description will discuss in detail embodiments of the present invention with reference to FIGS. 1 through 7. A heat-resistant separator for a battery such as a lithium-ion secondary battery will be described below as an example of a separator film, for a battery, to be wound around a separator film winding core (core) in accordance with an embodiment of the present invention.

<Configuration of Lithium-Ion Secondary Battery>

A lithium-ion secondary battery will be described below with reference to FIGS. 1 through 3.

A nonaqueous electrolyte secondary battery, typified by a lithium-ion secondary battery, has a high energy density, and therefore is currently and widely used as (i) batteries for use in devices such as personal computers, mobile phones and mobile information terminals, and moving bodies such as automobiles and airplanes, and (ii) stationary batteries contributing to stable power supply.

FIG. 1 is a view schematically illustrating a cross sectional configuration of a lithium-ion secondary battery 1.

As illustrated in FIG. 1, the lithium-ion secondary battery 1 includes a cathode 11, a separator 12, and an anode 13. Outside the lithium-ion secondary battery 1, an external device 2 is connected between the cathode 11 and the anode 13. Electrons move in a direction A while the lithium-ion secondary battery 1 is being charged, and the electrons move in a direction B while the lithium-ion secondary battery 1 is being discharged.

<Separator>

The separator 12 is provided so as to be sandwiched between (i) the cathode 11 which is a positive electrode of the lithium-ion secondary battery 1 and (ii) the anode 13 which is a negative electrode of the lithium-ion secondary battery 1. The separator 12 allows lithium ions to move between the cathode 11 and the anode 13 whereas the separator 12 separates the cathode 11 from the anode 13. The separator 12 is made of, for example, polyolefin such as polyethylene or polypropylene.

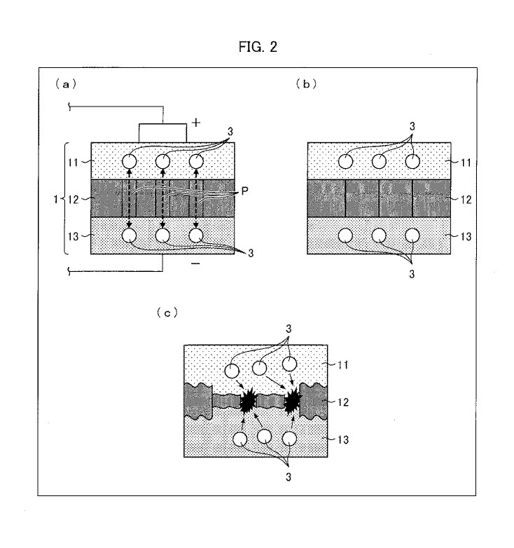

FIG. 2 is a view schematically illustrating states of the lithium-ion secondary battery 1 illustrated in FIG. 1. (a) of FIG. 2 illustrates a normal state. (b) of FIG. 2 illustrates a state in which a temperature of the lithium-ion secondary battery 1 has risen. (c) of FIG. 2 illustrates a state in which the temperature of the lithium-ion secondary battery 1 has sharply risen.

As illustrated in (a) of FIG. 2, the separator 12 has many pores P. Normally, lithium ions 3 can move back and forth in the lithium-ion secondary battery 1 through the pores P.

The temperature of the lithium-ion secondary battery 1 may rise due to, for example, excessive charging of the lithium-ion secondary battery 1 or a high current caused by short-circuiting of an external device. This causes the separator 12 to be melt or soften, so that the pores P are blocked as illustrated in (b) of FIG. 2. As a result, the separator 12 shrinks. This causes the lithium ions 3 to stop moving back and forth, and ultimately causes the temperature of the lithium-ion secondary battery 1 to stop rising.

Note, however, that in a case where the temperature of the lithium-ion secondary battery 1 sharply rises, the separator 12 suddenly shrinks. In this case, the separator 12 may be destroyed (see (c) of FIG. 2). This causes the lithium ions 3 to leak out from the separator 12 which has been destroyed. As a result, the lithium ions 3 will never stop moving back and forth. Consequently, the temperature of the lithium-ion secondary battery 1 continues to rise.

<Heat-Resistant Separator>

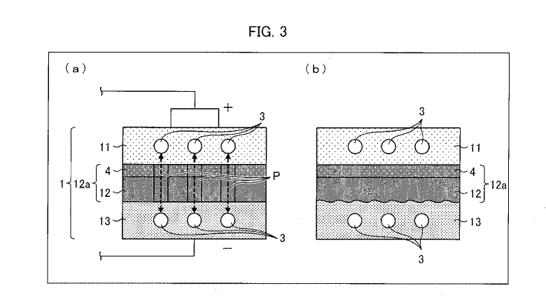

FIG. 3 is a view schematically illustrating states of a lithium-ion secondary battery 1 different in configuration from the lithium-ion secondary battery 1 illustrated in FIG. 1. (a) of FIG. 3 illustrates a normal state, and (b) of FIG. 3 illustrates a state in which a temperature of the lithium-ion secondary battery 1 has sharply risen.

As illustrated in (a) of FIG. 3, the lithium-ion secondary battery 1 can further include a heat-resistant layer 4. This heat-resistant layer 4 can be provided on the separator 12. (a) of FIG. 3 illustrates a configuration in which the separator 12 is provided with the heat-resistant layer 4 serving as a functional layer. Hereinafter, a film in which the separator 12 is provided with the heat-resistant layer 4 is referred to as a heat-resistant separator 12a that is an example of a functional layer-attached separator. The separator 12 in the functional layer-attached separator serves as a base material for the functional layer.

According to the configuration illustrated in (a) of FIG. 3, the heat-resistant layer 4 is stacked on a surface of the separator 12 which surface faces the cathode 11. Note that the heat-resistant layer 4 can be alternatively stacked (i) on a surface of the separator 12 which surface faces the anode 13 or (ii) on the both surfaces of the separator 12. The heat-resistant layer 4 has pores which are similar to pores P. Normally, lithium ions 3 move back and forth through the pores P and the pores of the heat-resistant layer 4. Materials of the heat-resistant layer 4 include, for example, wholly aromatic polyamide (aramid resin).

Even in a case where the separator 12 melts or softens due to a sharp rise in temperature of the lithium-ion secondary battery 1, the shape of the separator 12 is maintained (see (b) of FIG. 3) because the heat-resistant layer 4 supports the separator 12. This causes the separator 12 to come off with melting or softening, so that the pores P only blocks up. This causes the lithium ions 3 to stop moving back and forth, and ultimately causes the above-described excessive discharging or excessive charging to stop. In this way, the separator 12 is prevented from being destroyed.

<Production Steps of Separator and Heat-Resistant Separator>

How to produce the separator and the heat-resistant separator of the lithium-ion secondary battery 1 is not specifically limited. The separator and the heat-resistant separator can be produced by a publicly known method. The following discussion assumes a case where a porous film from which the separator (heat-resistant separator) is made contains polyethylene as a main material. Note, however, that even in a case where the porous film contains another material, the separator (heat-resistant separator) can be produced by a similar production method.

Examples of such a similar production method encompass a method which includes the steps of forming a film by adding an inorganic filler or a plasticizer to a thermoplastic resin, and then removing the inorganic filler or the plasticizer with an appropriate solvent. For example, in a case where the porous film is a polyolefin separator made of a polyethylene resin containing ultra-high molecular weight polyethylene, the separator (heat-resistant separator) can be produced by the following method.

This method includes (1) a kneading step of kneading a ultra-high molecular weight polyethylene with (i) an inorganic filler (such as calcium carbonate or silica) or (ii) a plasticizer (such as low molecular weight polyolefin or fluid paraffin) to obtain a polyethylene resin composition, (2) a rolling step of rolling the polyethylene resin composition to form a film thereof, (3) a removal step of removing the inorganic filler or the plasticizer from the film obtained in the step (2), and (4) a stretching step of stretching the film obtained in the step (3) to obtain the porous film. The step (4) can be alternatively carried out between the steps (2) and (3).

In the removal step, many fine pores are formed in the film. The fine pores of the film stretched in the stretching step serve as the above-described pores P. The porous film (separator 12) is thus obtained. Note that the porous film is a polyethylene microporous film having a prescribed thickness and a prescribed air permeability.

Note that, in the kneading step, (i) 100 parts by weight of the ultra-high molecular weight polyethylene, (ii) 5 parts by weight to 200 parts by weight of a low molecular weight polyolefin having a weight-average molecular weight of 10000 or less, and (iii) 100 parts by weight to 400 parts by weight of the inorganic filler can be kneaded.

Thereafter, in a coating step, the heat-resistant layer 4 is formed on the porous film. For example, by applying, onto the porous film, an aramid/NMP (N-methyl-pyrrolidone) solution (coating solution), the heat-resistant layer 4 that is an aramid heat-resistant layer is formed. The heat-resistant layer 4 can be formed on a single surface or both surfaces of the porous film. Alternatively, the heat-resistant layer 4 can be formed on the porous film, by coating the porous film with a mixed solution containing a filler such as alumina/carboxymethyl cellulose.

Note that, in the coating step, an adhesive layer can be formed on the porous film, by applying a polyvinylidene fluoride/dimethyl acetamide solution (coating solution) on the porous film (application step) and depositing the coating solution (depositing step). The adhesive layer can be formed on the single surface of the porous film or on the both surfaces of the porous film.

A method of coating the porous film with a coating solution is not specifically limited, provided that uniform wet coating can be carried out by the method. As the method employed is a conventionally publicly known method such as a capillary coating method, a spin coating method, a slit die coating method, a spray coating method, a dip coating method, a roll coating method, a screen printing method, a flexo printing method, a bar coater method, a gravure coater method, or a die coater method. The heat-resistant layer 4 has a thickness which can be controlled by adjusting a thickness of a coating wet film or a solid-content concentration in the coating solution.

A polyolefin base material porous film to be coated is fixed or transferred with a support. As the support used is a resin film, a metal belt, a drum or the like.

The separator 12 (heat-resistant separator) can thus be produced in which the heat-resistant layer 4 is stacked on the porous film. The separator thus produced is wound around a core having a cylindrical shape. Note that a subject to be produced by the above production method is not limited to the heat-resistant separator. The above production method does not necessarily include the coating step. In a case where no coating step is included in the production method, the subject to be produced is a separator including no heat-resistant layer.

<Slitting Apparatus>

The heat-resistant separator or the separator including no heat-resistant layer (hereinafter, referred to as “separator”) preferably has a width (hereinafter, referred to as “product width”) suitable for application products such as the lithium-ion secondary battery 1. Note, however, that the separator is produced so as to have a width that is equal to or larger than a product width, in view of an improvement in productivity. After the separator is once produced, the separator is cut (slit) into a separator(s) having the product width.

Note that the “width of the separator” means a length of the separator which length extends (i) in parallel with a plane along which the separator extends and (ii) in a direction perpendicular to a lengthwise direction of the separator. Hereinafter, a wide separator which has not slit is referred to as an “original sheet,” whereas particularly a separator which has been slit is referred to as a “slit separator.” Note also that (i) “slitting” means to cut the separator in the lengthwise direction (a direction in which a film flows during production; MD: Machine direction) and (ii) “cutting” means to cut the separator in a transverse direction (TD). Note that the transverse direction (TD) means a direction which is (i) parallel to the plane along which the separator extends and (ii) substantially perpendicular to the lengthwise direction (MD) of the separator.

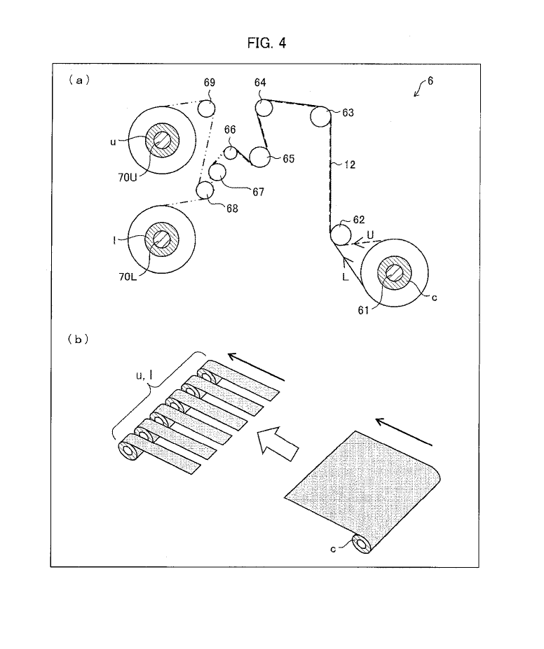

FIG. 4 is a view schematically illustrating a configuration of a slitting apparatus 6 for slitting the separator. (a) of FIG. 4 illustrates an entire configuration, and (b) of FIG. 4 illustrates arrangements before and after slitting the original sheet.

As illustrated in (a) of FIG. 4, the slitting apparatus 6 includes a rotatably-supported cylindrical wind-off roller 61, rollers 62 through 69, and take-up rollers 70U and 70L.

(Before Slitting)

In the slitting apparatus 6, a cylindrical core c around which the original sheet is wrapped is fitted on the wind-off roller 61. As illustrated in (b) of FIG. 4, the original sheet is wound off from the core c to a route U or L. The original sheet which has been thus wound off is transferred to the roller 68 via the rollers 63 through 67. While the original sheet is being transferred, the original sheet is slit into a plurality of slit separators. Note that the number and arrangement of the rollers 62 through 69 can be changed in order to transfer the original sheet in a desired pathway.

(After Slitting)

As illustrated in (b) of FIG. 4, some of the plurality of slit separators are wound around respective cylindrical cores u which are fitted on the take-up roller 70U. Meanwhile, the others of the plurality of slit separators are wound around respective cylindrical cores 1 (separator winding cores), which are fitted on the take-up roller 70L. Note that (i) the slit separators each wound around in a roll manner and (ii) the respective cores u and 1 are, as a whole, referred to as a “roll (separator roll)”.

<Separator Winding Core and Separator Roll>

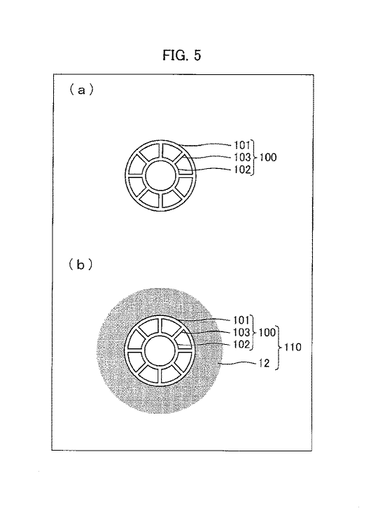

FIG. 5 is a front view illustrating a core, and a roll in which a separator is wound around the core.

A shaft of a take-up roller or the like is fitted in an inner cylindrical member 102 of a core 100 illustrated in (a) of FIG. 5. The core 100 is rotated, so that the separator 12 is wrapped around an outer cylindrical member 101 with a certain level of tension. This makes it possible to produce a roll 110 illustrated in (b) of FIG. 5.

The core 100 is applicable to, for example, the cores u and 1 of the slitting apparatus 6 illustrated in FIG. 4. That is, the separator 12 can be wound around the core 100 in the same manner as the above-described method.

<Structure of Core>

The core 100 illustrated in (a) of FIG. 5 includes the outer cylindrical member 101, the inner cylindrical member 102, and a plurality of ribs 103. The outer cylindrical member 101 defines an outer peripheral surface of the core 100 around which outer peripheral surface the separator 12 is to be wound. The inner cylindrical member 102 is provided on an inner side of the outer cylindrical member 101, and functions as a bearing in which a shaft of, e.g., a take-up roller which rotates the core is to be fitted. The ribs 103 each are a support member which (i) radially extends between the outer cylindrical member 101 and the inner cylindrical member 102 and (ii) connects to the outer cylindrical member 101 and the inner cylindrical member 102.

According to the present embodiment, the ribs 103 are provided (i) at equal intervals in respective eight places into which a circumference of the core is equally divided and (ii) so as to be perpendicular to the outer cylindrical member 101 and the inner cylindrical member 102. Note, however, that the number of ribs and intervals at which the ribs are provided are not limited to the above.

It is preferable that a center of a circumference of the outer cylindrical member 101 be substantially identical to that of a circumference of the inner cylindrical member 102. The present invention is, however, not limited to this. Dimensions such as a thickness of, a width of an outer peripheral surface of, and a radius of each of the outer cylindrical member 101 and the inner cylindrical member 102 can be designed as appropriate according to, for example, the type of separator to be produced.

The core 100 usually has a weight of 250 g to 800 g.

The core 100 has side surfaces each of which surface area is usually 10 cm² to 80 cm² around which side surfaces the separator 12 is not to be wound.

The roll 110 usually has a weight of 400 g to 6000 g.

As a material of the core 100, there is suitably employed a resin containing any one of an ABS resin, a polyethylene resin, a polypropylene resin, a polystyrene resin, a polyester resin, and a vinyl chloride resin. In a case where the core 100 is made of the resin, the core 100 can be produced by resin molding with the use of a mold.

<Stacking of Core>

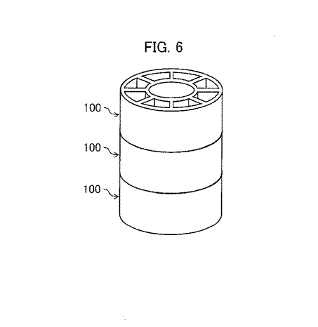

FIG. 6 is a view illustrating a state where cores 100 are stacked.

In a case where an outer peripheral surface of the outer cylindrical member 101 around which outer peripheral surface the separator 12 is to be wound is damaged by, for example, contact with the ground, the damage of the outer peripheral surface causes the separator 12 wound around the damaged outer peripheral surface to be damaged. Moreover, a foreign material sometimes accumulates in the damage. In this case, the accumulated foreign material adheres to the separator 12 wound around the damaged outer peripheral surface. This will remotely cause a defect of the separator 12.

The core therefore needs to be stored while the outer peripheral surface of the outer cylindrical member 101 is kept from contact with the ground or the like as far as possible.

The cores 100 are stacked such that one of side surfaces of each of the cores 100 around which side surfaces no separator 12 is to be wound face upward while the other one of the side surfaces of each of the cores 100 face downward (see FIG. 6). This makes it possible to store the cores 100 while preventing outer peripheral surfaces of outer cylindrical members 101 of the respective cores 100 from contacting the ground.

In FIG. 6, three cores 100 are stacked. However, the number of cores 100 stacked for storage is not limited to this value, provided that at least two cores are stacked on top of each other. Four or more cores can also be stacked to be stored.

In a case where the stacked cores 100 are actually stored, a human or an object may accidentally contact the stacked cores 100. When collectively conveyed, the stacked cores 100 will be vibrated.

In a case where a frictional force between the side surfaces of the stacked cores 100 is small, generation of such an impact or vibration or the like on the stacked cores 100 will cause the stacked cores 100 to be greatly misaligned, whereby the stacked cores 100 will collapse.

<Method of Fixing Cores>

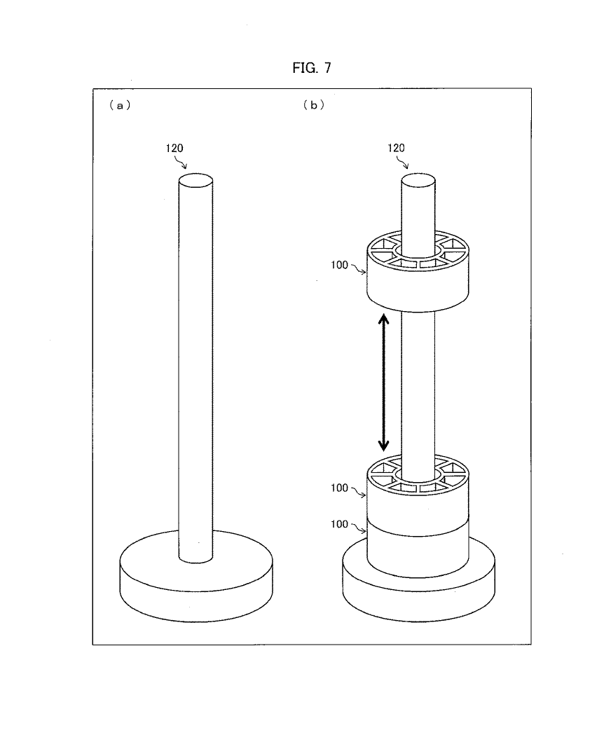

Examples of a method of fixing the stacked cores 100 so that the stacked cores 100 do not collapse include a method of fixing the stacked cores 100 by use of a mount 120 (see (a) of FIG. 7) that includes (i) a circular flat base, and (ii) a long cylindrical shaft which extends from an approximate center of a plane of the base in a direction substantially perpendicular to the base.

A diameter of the shaft of the mount 120 is slightly smaller than an inner diameter of the inner cylindrical member 102 of the core 100. As illustrated in (b) of FIG. 7, the shaft of the mount 120 is passed through holes of the inner cylindrical members 102 of the cores 100, so that the cores 100 are stacked and fixed.

In a case where the mount 120 is used for storage of the core 100, stacking the core 100 on the mount 112 requires the core 100 to be moved greatly from the top of the shaft of the mount 120 to the bottom of the shaft of the mount 120. In contrast, taking out the core 100 from the mount 120 requires the core 100 to be moved greatly from the bottom to the top. This requires time and labor to handle the core 100, and causes inefficiency of work.

Moreover, in a case where the core 100 is stacked on the mount 120 or taken out from the mount 120, an inner peripheral surface of the inner cylindrical member 102 of the core 100 is sometimes rubbed against the shaft of the mount 120. This will cause a scratch on the inner cylindrical member 102. In this case, for example, a foreign material or the like accumulates in the scratch, and adheres to the separator 12. This will remotely cause a defect of the separator 12.

<Surface Roughness of Side Surface>

In order to address the problems, it is necessary to prevent the stacked cores 100 from being misaligned without having to use any fixing tool such as the mount 120. One solution to the problems is to increase a frictional force between the side surfaces of the cores 100 so that the cores 100 are less misaligned.

In a case where the frictional force between the side surfaces of the cores 100 is sufficiently large, even a certain degree of external force generated on the stacked cores 100 does not cause the stacked cores 100 to be misaligned. The cores 100 can ultimately avoid collapsing.

The inventor of the present invention focused on improving surface roughnesses of the side surfaces of the cores 100 so as to increase the frictional force between the cores 100.

For example, an arithmetic mean roughness can be employed as a reference of a surface roughness. The arithmetic mean roughness represents a sum, per unit area, of absolute values of sizes of unevenness of a surface whose average height serves as a reference. A frictional force between surfaces each having a large arithmetic mean roughness tends to increase. Note, however, that a frictional force between surfaces each having an excessively large arithmetic mean roughness sometimes decreases rather than increases because the surfaces contact each other almost at points. In view of this, arithmetic mean roughnesses of the side surfaces of the cores 100 are preferably not more than 10 μm, and more preferably not more than 3 μm, from the viewpoint of increasing the frictional force between the side surfaces of the cores 100.

It is more preferable that arithmetic mean roughnesses of both side surfaces of each of the cores 100 fall within the above range.

It is possible to adjust the arithmetic mean roughnesses of the side surfaces of the cores 100 by (i) roughening surfaces of separator winding cores by, for example, blasting or (ii) smoothing the surfaces of the separator winding cores by, for example, polishing. Alternatively, the arithmetic mean roughnesses of the side surfaces of the cores 100 can be adjusted with a processed metal mold for use in production of the separator winding cores.

<Ease of Cleaning>

A surface whose arithmetic mean roughness is remarkably large has a problem that, in a case where a fine foreign material adheres to the surface, it is difficult to clean the fine foreign material off the surface.

In an actual process of producing a battery, a core 100 is recyclable as follows: after a separator 12 is wound off from a roll 110, the core 100 is cleaned, and another separator 12 is wound around the cleaned core 100. While the core 100 is being cleaned, it is necessary to remove a foreign material which has adhered to the core 100. Otherwise, the foreign material remains on the core 100 and adheres to the another separator 12. This will lead to a defect in the another separator 12.

In a case where the core 100 has a side surface whose arithmetic mean roughness is larger than necessary, the foreign material fails to be sufficiently removed from the core 100 in a cleaning step of cleaning the core 100. As a result, the core 100 will not be recyclable. In a case where it takes time to remove the foreign material in the cleaning step, another problem is caused that a step of recycling the core 100 is prolonged.

In view of the above, the inventor of the present invention found that the side surface of the core 100 is required to have an appropriate degree of surface roughness so as to have (i) a frictional force between the side surface and a side surface of another core 100 and (ii) ease of cleaning.

A core 100 having a side surface whose roughness falls within the above range is advantageous in that rolls 110 each of which includes the core 100 and a separator 12 wound around the core 100 are less likely to be misaligned when the rolls 110 are stacked. Such an advantage is brought about by a roll 110 in which a separator 12 is wound around the core 100, the separator 12 having a width smaller than a length of the core 100 in a direction of a thickness of the core 100.

In the roll 110, the core 100 only needs to protrude from at least one of side surfaces of the separator 12 which is wound around the core 100. The core 100 preferably protrudes not less than 1 mm from at least one of the side surfaces of the wound separator 12, from the viewpoint of preventing the separator 12 from being damaged.

<Measuring Experiments on Cores>

On the basis of the above, the inventor of the present invention conducted experiments on cores 100 having different surface roughnesses to evaluate frictional forces and ease of cleaning of the cores 100.

First, a plurality of cores A identical in shape to the core 100 were prepared. Then, measurement of arithmetic mean roughnesses of side surfaces was made on each of the cores A. Note that the cores A are substantially identical in configuration and physical property to each other.

Specifically, arithmetic mean roughnesses of side surfaces of each of the cores A were measured. A “HANDYSURF E-35A” (manufactured by TOKYO SEIMITSU CO., LTD.) was used as a surface roughness measurement apparatus. A tip of a probe of a measurement head was cone-shaped with an angle of 60 degrees. The tip had a radius of 2 μm. In the present embodiment, the surface roughness measurement apparatus was set such that measurement force was 0.75 mN, measurement speed was 0.5 mm/s, evaluation length was 4.0 mm, and cutoff value was 0.8 mm. Since roughnesses of the side surfaces of each of the cores 100 are deemed to be substantially uniform, an average value of arithmetic mean roughnesses measured at different ten locations on each of the side surfaces of each of the cores A was assumed to be an arithmetic mean roughness of each of the side surfaces of each of the cores A.

Next, an experiment was conducted to measure a frictional force of each of the side surfaces of each of the cores A.

First, with use of each of the cores A as illustrated in (a) of FIG. 5, individual rolls A were produced. Each of the cores A had (i) an outer cylindrical member of 6 inches in outer diameter, (ii) an inner cylindrical member of 3 inches in inner diameter, (iii) a thickness of 65 mm, (iv) eight ribs provided in corresponding eight places into which a circumference of the core A was equally divided, (v) the side surfaces each of which surface area was 41 cm², and (vi) a weight of 0.36 kg. Each separator 12 having a width of 60 mm was wound around a center part of an outer peripheral surface of the outer cylindrical member of each of the cores A. This prepared the rolls A each having a weight of 1.25 kg. Next, on a leveled truck having a non-slip rubber mat laid thereon, the prepared rolls A were stacked into a two-tier stack such that their respective cores A were aligned when viewed from above. After that, the truck was moved on a flat road by 5 m at a constant speed of 30 m per minute, and was then suddenly stopped.

All misalignments which the two-tier stack of the rolls A underwent at the sudden stop were measured. Of all the measured misalignments, the largest amount of misalignment was used to evaluate a frictional force. Note that a core having a misalignment of less than 2 mm was evaluated as “Good”, a core having a misalignment of not less than 2 mm but less than 5 mm was evaluated as “Fair”, and a core having a misalignment of not less than 5 mm was evaluated as “Poor”.

Finally, an experiment was conducted to evaluate ease of cleaning of the side surfaces of each of the cores A.

Particles of acetylene black were spread on the side surfaces of each of the cores A, and the particles were then rubbed on the side surfaces of each of the cores A with a nonwoven fabric made of pulp, so that black dirt adhered to the side surfaces of each of the cores A. The black dirt is assumed to be, for example, a positive electrode material and a negative electrode material of an electrically conductive battery which positive electrode material and negative electrode material will possibly adhere to the core 100 in the actual step of producing the battery.

The side surfaces of each of the cores A to which the black dirt adhered were wiped with a nonwoven fabric dampened with ethanol. Each of the cores A was repeatedly checked by visual observation to see whether or not the black dirt was removed.

On the basis of how many times the side surfaces of each of the cores A was cleaned in the above manner, ease of cleaning of the side surfaces of each of the cores A was evaluated. In a case where the black dirt was removed in the first, second or third cleaning, a core was evaluated as “Good”. In a case where the black dirt was not removed in the first, second or third cleaning but was removed in the fourth or fifth cleaning, a core was evaluated as “Fair”. In a case where the black dirt was not removed even in the fifth cleaning, a core was evaluated as “Poor”.

<Experimental Results>

The above evaluation experiments conducted on the cores A were conducted in the same manner on cores B through G whose respective side surfaces were different in surface roughness from one another. Note that the cores B through G were identical in shape to the core 100. Table 1 below shows results of the evaluation experiments conducted on the respective cores A through G.

TABLE 1

| | Arithmetic Mean | Frictional | Ease of |
|---|---|---|---|
| | Roughness (μm) | Force | Cleaning |
| Core A | 0.15 | Poor | Good |
| Core B | 0.26 | Fair | Good |
| Core C | 0.4 | Good | Good |
| Core D | 0.55 | Good | Good |
| Core E | 0.77 | Good | Fair |
| Core F | 1 | Good | Poor |
| Core G | 2.92 | Good | Poor |

In Table 1, data given under “Arithmetic Mean Roughness (μm)” are measured values of arithmetic mean roughnesses of the side surfaces of the respective cores A through G, data given under “Frictional Force” are results of frictional force evaluations of the respective cores A through G, and data given under “Ease of Cleaning” are results of eases-of-cleaning evaluations of the respective cores A through G.

<Evaluation of Cores>

The experimental result of the core A shows that in a case where the arithmetic mean roughness of the side surfaces of the core 100 is not more than 0.15 μm, the roll 110, in which the separator 12 is wound around the core 100, has a side surface whose frictional force is small. This suggests that the rolls 110 stacked for storage will undergo a large amount of misalignment and will probably be fell down.

The experimental results of the cores F and G show that in a case where the arithmetic mean roughness of the side surfaces of the core 100 is not less than 1.00 μm, it is difficult to clean the side surfaces of the core 100. This suggests that dirt which adheres to the core 100 will probably become a remote cause of a defect of the separator 12 to be wound around the core 100.

In contrast, the experimental results of the cores B and E show that the cores B and E each have both a frictional force and ease of cleaning to some extent, and are therefore suitably used as an actual core 100. The experimental results of the cores C and D show that the cores C and D are excellent in frictional force and ease of cleaning, and are therefore remarkably suitable for the actual core 100.

<Summary>

On the basis of these experimental results, it is presumable that the roll 110 is preferably configured to be a roll in which the separator 12 is wound around the core 100 having side surfaces at least one of which has an arithmetic mean roughness of not less than 0.16 μm. The configuration makes it possible to realize a roll 110 which is less likely to fall down when the roll 110 is stacked to be stored. Stacking the roll 110 to be stored makes it easy to store not only the core 100 but also the separator 12 wound around the core 100 while keeping the separator 12 from contact with an object such as the ground.

As such, the core 100 is preferably configured so that the arithmetic mean roughness of at least one of the side surfaces of the core 100 is not less than 0.16 μm. The configuration makes it possible to realize a core 100 which is less likely to fall down when the core 100 is stacked in a state where no separator 12 is wound around the core 100.

Note that in a case where two cores 100 are stacked to be stored, an arithmetic mean roughness of either one of both side surfaces of each of the two cores 100 only needs to be not less than 0.16 μm. In this case, the two cores 100 are stacked such that the side surface, of one of the two cores 100, whose arithmetic mean roughness is not less than 0.16 μm contacts the side surface, of the other one of the two cores 100, whose arithmetic mean roughness is not less than 0.16 μm. The cores 100 stacked in the above manner are less likely to slide each other. The two cores 100 are thus easily stacked together for storage.

In a case where the both side surfaces of the core 100 have an arithmetic mean roughness of not less than 0.16 μm, three or more cores 100 are easily stacked together for storage. In this case, it is also possible to increase a frictional force between (i) the ground on which one of the three or more cores 100 is to be placed during storage and (ii) the one of the three or more cores 100, thereby preventing the one of the three or more cores 100 from sliding. It is therefore possible to more efficiently prevent the three or more stacked cores 100 from collapsing.

Moreover, the core 100 is preferably configured so that the arithmetic mean roughness of at least one of the side surfaces of the core 100 is not more than 0.9 μm. The configuration makes it possible to provide an easily cleanable core 100. A roll 110 in which a separator 12 is wound around the easily cleanable core 100 is preferable because the core 100 from which the separator 12 has been wound off is easily cleaned.

The present invention is not limited to the embodiments, but can be altered by a skilled person in the art within the scope of the claims. An embodiment derived from a proper combination of technical means each disclosed in a different embodiment is also encompassed in the technical scope of the present invention.

### REFERENCE SIGNS LIST

1: Lithium-ion secondary battery
2: External device
3: Lithium ion
4: Heat-resistant layer
11: Cathode
12: Separator
12a: Heat-resistant separator
13: Anode
100: Core
110: Roll
120: Mount

1. A separator winding core around which a nonaqueous electrolyte secondary battery separator is to be wound,
the separator winding core having side surfaces around which the nonaqueous electrolyte secondary battery separator is not to be wound and at least one of which side surfaces has an arithmetic mean roughness of not less than 0.16 μm.

2. The separator winding core as set forth in claim 1, wherein the arithmetic mean roughness is not more than 3 μm.

3. The separator winding core as set forth in claim 2, wherein the arithmetic mean roughness is not more than 0.9 μm.

4. The separator winding core as set forth in claim 1, wherein the separator winding core is stackable, with one or more other separator winding cores of the same type, in such a position that one of the side surfaces of the separator winding core faces upward while the other one of the side surfaces of the separator winding core faces downward.

5. The separator winding core as set forth in claim 1, wherein the separator winding core is made of any one of an ABS resin, a polyethylene resin, a polypropylene resin, a polystyrene resin, a polyester resin, and a vinyl chloride resin.

6. A separator roll in which a nonaqueous electrolyte secondary battery separator is wound around a separator winding core recited in claim 1.

7. The separator roll as set forth in claim 6, wherein the separator winding core has a width larger than that of the nonaqueous electrolyte secondary battery separator.

8. A method of producing a separator roll in which a nonaqueous electrolyte secondary battery separator is wound around a separator winding core,
the method comprising the steps of:
producing the nonaqueous electrolyte secondary battery separator; and
winding the nonaqueous electrolyte secondary battery separator around the separator winding core,
the separator winding core having side surfaces around which the nonaqueous electrolyte secondary battery separator is not to be wound and at least one of which side surfaces has an arithmetic mean roughness of not less than 0.16 μm.

9. The method as set forth in claim 8, wherein the arithmetic mean roughness is not more than 3 μm.

10. The method as set forth in claim 9, wherein the arithmetic mean roughness is not more than 0.9 μm.
